(19) United States
(12) Patent Application Publication
(10) Pub. No.: US 2010/0232389 A1
(43) Pub. Date: Sep. 16, 2010

(54) METHOD AND SYSTEM FOR HIGH SPEED INTRA-DOMAIN MOBILITY MANAGEMENT USING DUAL INTERFACES IN WIRELESS LAN/MAN

(75) Inventor: Jong-Tae Park, Daegu (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Kyungpook National University Industry-Academic Cooperation Foundation, Daegu (KR)

(21) Appl. No.: 12/279,959

(22) PCT Filed: Mar. 29, 2007
(86) PCT No.: PCT/KR2007/001531

§ 371 Date: Jun. 2, 2010

(30) Foreign Application Priority Data
Mar. 29, 2006 (KR) 10-2006-0028211

(51) Int. Cl. H04W 36/00

(52) U.S. Cl. 370/331

(57) ABSTRACT

The present invention relates to a fast intra-domain mobility management method and system. The fast intra-domain mobility management method and system are configured to enable handover stably and intelligently with respect to complicated electric wave characteristics in such a manner that in order to provide an efficient inter-AP handover function at high speed without data loss or delay upon movement, two LAN/MAN interfaces, operating according to the alternate make-before-break principle, is mounted in the existing wireless communication terminal, PDA, notebook, or smart phone without changing the infrastructure of the wireless LAN and MAN, and in order to minimize unnecessary handover due to an abrupt change of the electric wave intensity, in a sleep state, whether to enter a preparation state is determined by comparing an estimated value of a moving average value with a preparation threshold value Tp set in memory, and in the preparation state, a probe message is sent to an AP, and the electric wave intensity of an AP that is in use or a switch threshold value Ts set in the memory is compared with the electric wave intensity of an AP that is in the preparation state for the handover, and fast switching is then performed. Accordingly, handover can be performed stably at high speed while saving power consumption when the mobile node moves. In particular, a ping-pong phenomenon that may occur when the mobile node frequently moves between the same neighboring cells can be reduced.

### TECHNICAL FIELD

The present invention relates to a fast intra-domain mobility management method and system that can provide real-time service, such as Voice Over Internet Protocol (VoIP), efficiently without data loss or delay upon movement at low or high speed by using the two LAN/MAN interfaces in a mobile node in wireless LAN and wireless MAN converged communication environments.

### BACKGROUND ART

The conventional techniques related to the present invention are described below. Recently, the use of IP-based real-time multimedia service, such as VoIP, has been drastically increased all over the world centering on advanced countries such the USA. In line with this trend, researches have been actively conducted on building wideband wireless mobile communication systems, such as All-IP-based 4G and wireless Metropolitan Area Network (MAN), throughout the world.

Furthermore, an IEEE 802.11-based wireless Local Area Network (LAN) system had been widely deployed in universities, companies, factories and so on, and installation areas thereof have recently been expanded to public areas such as hotspots. However, the conventional wireless LAN/MAN system has several problems in that it cannot meet user's requirements for real-time multimedia service such as VoIP.

One of the conventional problems resides in mobility management, security and operational management from a user's point of view. In particular, although the WiFi wireless LAN based on IEEE 802.11 international standard has a relatively wide bandwidth of a few tens of Mbps or a few hundreds of Mbps, it does not support a fast mobility management function necessary to provide a real-time multimedia service when a user moves across cells at low or high speed.

In addition, WiMax wireless MAN based on the IEEE 802.16 international standard is also problematic in that it does not support mobility. IEEE 806.16e standard that has recently been completed has a limited data transfer rate (about 15 Mbps) and requires a new communication infrastructure for construction in a wide area. Thus, the Wibro IEEE 806.16e standard is problematic in that it requires high construction investment expenses.

### DISCLOSURE OF INVENTION

### Technical Problem

Accordingly, the present invention has been made keeping in an effort to solve the above problems occurring in the prior art, and an object of the present invention is to provide a fast intra-domain mobility management method and system in which an inter-Access Point (AP) handover function can be provided efficiently at high speed without data loss or delay upon movement by mounting two LAN/MAN interfaces, operating according to an alternate make-before-break principle, in the existing wireless communication terminals, PDAs, notebooks, next-generation notebooks or smart phones without changing the infrastructure of the wireless LAN or MAN systems. In the present invention, the term “LAN or MAN interface” refers to a communication network interface of a data link layer, including a physical layer and a Media Access Control (MAC) layer. The term “wireless LAN/MAN” in the present invention implies network interfaces which are comprised of two IEEE 802.11 LAN interfaces, or two IEEE 802.16 MAN interfaces, or one IEEE 802.11 LAN interface and one IEEE 802.16 MAN interface. IEEE 802.16e standard is not included, because it supports layer 2 mobility function. The term “access point (AP)” in the current invention implies base station in LAN or MAN.

Another object of the present invention is to enable handover stably and intelligently with respect to complicated electric wave characteristics. In order to minimize unnecessary handover due to an abrupt change of the electric wave intensity, two interfaces are mounted in the mobile node, in such a manner that in a sleep state, an estimated value of a moving average value of the electric wave intensity, i.e., received signal strength indicator (RSSI), is compared with a preparation threshold value Tp set in memory in order to determine whether to enter a preparation state. And in the preparation state, a probe message is sent to an AP, and the electric wave intensity of an AP that is in use or a switch threshold value Ts set in the memory is compared with the electric wave intensity of an AP that is in the preparation state for the handover, and fast switching of AP attachment point is then timely executed.

Still another object of the present invention is to minimize power consumption of the mobile node and perform handover between APs at high speed in such a manner that the interface is operated according to three steps of a sleep state, a preparation state and an active state by using two LAN/MAN interfaces mounted in the mobile node in order to prevent data loss.

### Technical Solution

To achieve the above objects, the present invention is configured to enable handover stably and intelligently with respect to complicated electric wave characteristics in such a manner that in order to provide an efficient inter-AP handover function at high speed without data loss or delay upon movement, two LAN/MAN interfaces, operating according to the alternate make-before-break principle, are mounted in the existing wireless communication terminal, PDA, notebook, next-generation notebook or smart phone without changing the infrastructure of the wireless LAN and MAN systems. In order to minimize unnecessary handover due to an abrupt change of the electric wave intensity, in a sleep state, an estimated value of a moving average value of the electric wave intensity, i.e., received signal strength indicator (RSSI), is compared with a preparation threshold value Tp set in memory in order to determine whether to enter a preparation state. In the preparation state, a probe message is sent to an AP, and the electric wave intensity of an AP that is in use or a switch threshold value Ts set in the memory is compared with the electric wave intensity of an AP that is in the preparation state for the handover, and fast switching of AP attachment point is then timely executed.

### ADVANTAGEOUS EFFECTS

The present invention has an advantage in that it can save power consumption, enables stable and intelligent handover with respect to complicated electric wave characteristics, and can reduce a ping-pong phenomenon that may occur when a mobile node moves between neighboring cells, by implementing a fast intra-domain mobility management method and system based on the alternate make-before-break principle, wherein two LAN/MAN interfaces are mounted in a mobile node such as PDA, notebook, or smart phone without changing a communication infrastructure of the wireless LAN and MAN systems, and two LAN/MAN interfaces can perform intelligent handover in accordance with the alternate make-before-break principle while undergoing the sleep state, the preparation state and the active state, providing real-time service efficiently without data loss or delay.

The present invention has another advantage in that it enables handover stably and intelligently with respect to complicated electric wave characteristics by using two interfaces mounted in the mobile node, in such a manner that in order to minimize unnecessary handover due to an abrupt change of the electric wave intensity, in a sleep state, whether to enter a preparation state is determined by comparing an estimated value of a moving average value with a preparation threshold value Tp set in memory. And in the preparation state, a probe message is sent to an AP, and the electric wave intensity of an AP that is in use or a switch threshold value Ts set in the memory is compared with the electric wave intensity of an AP that is in the preparation state for the handover, and fast switching of AP attachment point is then timely executed.

The present invention has still another advantage in that it can minimize power consumption of the mobile node and perform handover between APs at high speed in such a manner that the interface is operated according to three steps of a sleep state, a preparation state and an active state by using two interfaces mounted in the mobile node in order to prevent data loss.

### BRIEF DESCRIPTION OF THE DRAWINGS

Further objects and advantages of the invention can be more fully understood from the following detailed description taken in conjunction with the accompanying drawings in which:

FIG. 1 shows an intra-domain wireless network structure;

FIG. 2 shows a wireless LAN/MAN protocol structure for fast intra-domain mobility management according to the present invention;

FIG. 3 is a state transition diagram of a mobile node according to the present invention;

FIG. 4 is a graph showing change in the electric wave intensity and the threshold value for state transition depending the movement of a mobile node according to the present invention;

FIG. 5 shows a fast intra-domain handover algorithm according to the present invention; and

FIG. 6 shows a signaling sequence diagram of intra-domain handover according to the present invention.

### BEST MODE FOR CARRYING OUT THE INVENTION

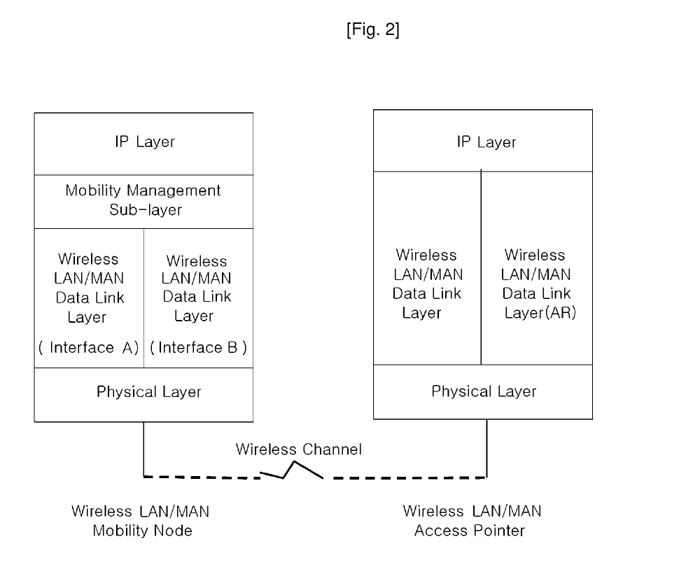

FIG. 2 shows a wireless LAN/MAN protocol structure for fast intra-domain mobility management according to the present invention. In FIG. 2, a mobility management sub-layer is configured to perform a handover function for fast intra-domain mobility management. A basic concept and idea of fast intra-domain handover mechanism according to the present invention is “alternate make-before-break using an intelligent mobility detection method.” In the concrete, the two LAN/MAN interfaces mounted in a mobile node operates as make-before-break. The operation is performed alternately as a harmonized operation. Such harmonization between two interfaces is governed by a Layer 3 sub-layer for mobility management as shown in FIG. 2.

### Mode for the Invention

The present invention will now be described in connection with specific embodiments with reference to the accompanying drawings.

In relation to Layer 2 mobility management, the wireless LAN does not provide the handover function. In the field of the wireless MAN, IEEE 802.16e has recently released mobile WiMAX international standard. In a Layer 3 mobility management method, techniques, such as Mobile IPv6 (MIPv6), Hierarchical MIPv6 (HMIPv6) and fast handover, have been manly researched and developed by IETF. The Layer 2 mobility management method deals with problems, such as maintaining QoS-guaranteed secure continuous connection over different APs connected to the same Access Router (AR). In the present invention, intra-domain mobility management refers to mobility management between APs when a mobile node moves between different cells within the same domain.

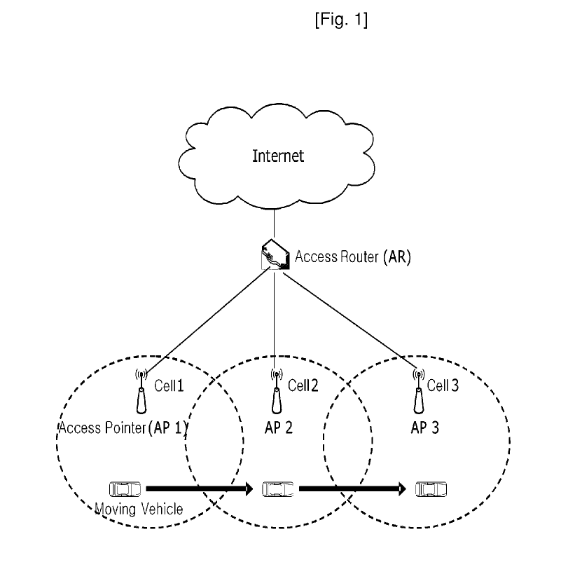

FIG. 1 illustrates the intra-domain wireless network structure for providing a network connection service with no disconnection when a mobile node moves at low or high speed between several APs connected to the same AR. Within the same domain, the IP address allocated to a mobile node does not change when the mobile node moves across the different cells as illustrated in FIG. 1. The mobile node refers to a terminal or terminal equipment having a wireless LAN/MAN access ability.

The intra-domain mobility management method according to the present invention is focused on mobility management in IEEE 802.11a/b/g/n wireless LAN international standard or IEEE 802.16 wireless MAN international standard, which is currently being developed, but can be applied to other similar or forthcoming wireless LAN/MAN technologies. Currently, the IEEE 802 11 a/b/g/n and IEEE 802.16 standards present a wireless access method within a region covered by one AP, that is, BSS (Basic Service Set) in IEEE 802.11, but do not deal with the connection problem associated with the mobility between APs.

The present invention relates to a new mobility management method that can support fast handover without delay or packet loss caused by movement when a mobile node changes a cell of an AP in wireless LAN/MAN environments without changing the existing IEEE 802.11a/b/g/n-based wireless LAN standard or IEEE 802.16-based wireless MAN standard. The present invention does not deal with mobility management which requires IP address change, such as the conventional MIPv4/v6, HMIPv6 and fast handover mechanism, but concerns about efficient mobility in an intra-domain by using a mobile node having two LAN/MAN interfaces mounted therein. The mobility management method according to the present invention is based on the alternate make-before-break principle, and it is configured to perform intelligent handover based on the alternate make-before-break principle in such a manner that two interfaces are mounted in a mobile node at Layer 2, as illustrated in FIG. 2, and the two interfaces provide an efficient real-time service without disconnection and without data loss and delay or packet loss while undergoing a sleep state, a preparation state and an active state.

A construction of the fast intra-domain mobility management structure according to the present invention is described below. FIG. 2 shows the wireless LAN/MAN protocol structure for fast intra-domain mobility management according to the present invention. As can be seen from FIG. 2, two wireless LAN/MAN interfaces are used for fast mobility management.

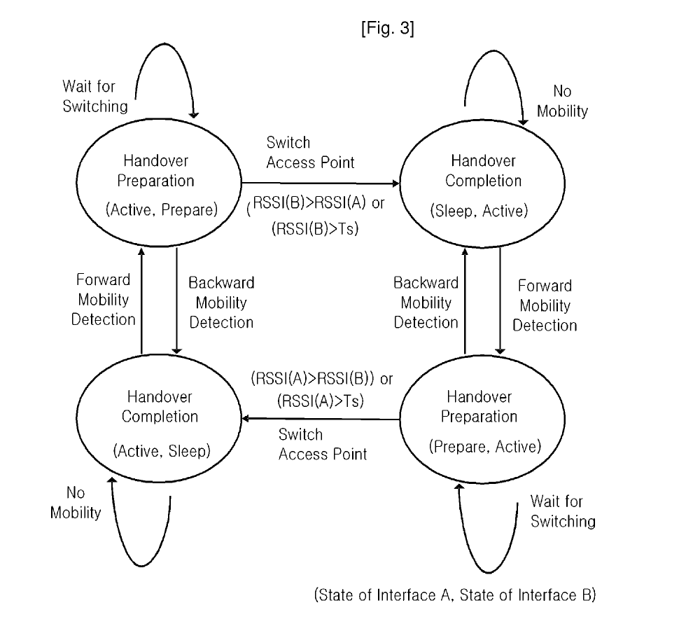

A construction related to state transition and intelligent mobility detection according to the present invention is described below. FIG. 3 shows a state transition diagram of a mobile node including two interfaces having an intelligent mobility detection function to which the alternate make-before-break principle according to the present invention is applied. States in FIG. 3 are defined as a pair of interfaces A and B. In FIG. 3, an Received Signal Strength Indicator (RSSI) (A) and an RSSI (B) refer to the radio signal strength indicators transmitted from mobile nodes, which are currently connected, to the interfaces A and B.

In FIG. 3, the definition of the states of the mobile node, which are related to mobility management, is as follows. The mobile node repetitively has a sleep state having almost no power consumption, a preparation state where handover is prepared, and a handover completion state. In the handover preparation state, one interface of a mobile node is connected to an AP and exchanges data therewith. The other interface of the mobile node is configured to prepare for the next connection to other cells when the mobile node moves. Detailed facts necessary for such preparation are described in detail in the following preparation state.

In the handover completion state, one interface of the mobile node transmits and receives data to and from an AP that is currently connected thereto, and the other interface of the mobile node is in the sleep state, that is, an inactive state while being disconnected from all other APs. The sleep state will be described in detail later on.

In FIG. 3, the definition of the interface state of each node is described below. The active state is a state where the connection to a specified AP is immediately activated and data is exchanged through the connected AP.

In the preparation state, access information, such as AP identifier, MAC address, access security request and RSSI, which are received from an adjacent AP that is, Nearby_AP, is examined, and an AP having the strongest electric wave intensity is selected as an AP that is, Next_AP to which connection will be made next, and a mobility management sub-layer is then prepared for handover. In the preparation operation, connection is set in advance by transmitting and receiving an authentication/authorization message and an association message to and from Next_AP. A probe message is then sent to the Next_AP and an RSSI is continuously measured to determine whether to enter the Next_AP cell.

In the sleep state, the connection to an AP that is currently being connected is immediately disconnected, and a corresponding interface is inactivated. An interface that is in the sleep state does not participate in data transmission, but only a beacon message that is broadcasted from a nearby AP, i.e., Nearby_AP, is received.

Referring to FIG. 3, mobility detection related to a state transition event is described below. A forward mobility detection event determines whether a mobile node that is in the handover completion state is moved in the direction of other adjacent AP by using the interface that is in the sleep state. A backward mobility detection event determines whether a mobile node that is in the handover preparation state has returned to a previous state. Finally, a no mobility event determines whether a mobile node that is in the handover completion state has moved very slowly or stopped. A wait-for-switching event determines whether the state of a mobile node is a state where handover is not yet to be performed though it is still moved. Finally, a switch AP event is an event to indicate that an AP must be changed.

Intelligent mobility detection is described below in detail. In general, an electric wave signal experiences a variety of electric wave interference phenomena, such as reflection, deflection, scattering and attenuation, depending on variation in surrounding environments upon transmission. In addition, the electric wave signal has a signal interference phenomenon depending on NLOS (Non Line-Of-Sight) and multi-path fading. Therefore, an RSSI received from the mobile node can have a value that varies regardless of the distance between a mobile node and an AP in complicated surrounding environments in which factories, buildings, etc. are closely located.

In particular, in the case where the mobile node moves between the cells here and there at high speed, the value of the electric wave intensity can fluctuate severely. In situation where the electric wave intensity fluctuates severely in the short run, in order to minimize the influence on mobility management, the estimated value of a moving average value of the electric wave intensity depending on variation in time is found, a moving average estimated value is examined and the movement of the mobile node, that is, mobility is detected in the present invention.

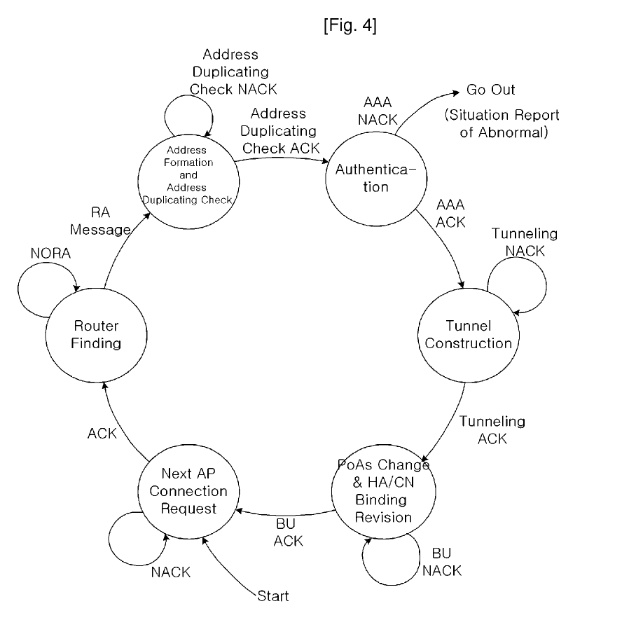

FIG. 4 shows variation in the electric wave intensity depending on the movement of a mobile node, and threshold values and related events for state transition. FIG. 4 shows the variation in the electric wave intensity RSSI (or SNR) received from Current_AP and Next_AP when a mobile node moves from Current_AP, that is, an AP that is currently being connected to Next_AP, that is, an AP that will be connected next at high speed. In FIG. 4, Tp and Ts indicate a preparation threshold value and a switch threshold value, respectively.

When the mobile node moves, an interface in the sleep state analyzes the electric wave intensity received from an adjacent AP. In this case, the mobile node usually receives a broadcasting beacon frame message that is periodically transmitted from an adjacent AP in order to save power consumption. An AP_id, a MAC_addr, the electric wave intensity RSSI, security rules related to access and so on, of a corresponding AP, are generally contained in the received information.

The mobile node that is in the sleep state analyzes these pieces of information and finds a moving average estimated value and the highest estimated value with respect to each AP adjacent to the mobile node. In this case, an AP having the highest estimated value becomes Next_AP. At this time, if the moving average estimated value of Next_AP is greater than Tp, it is determined that the mobile node is being moved. Thus, the interface of the mobile node that is in the sleep state enters the preparation state for handover, as illustrated in FIG. 4. In this case, the reason why the moving average value is used instead of an instant electric wave intensity value is that the influence by various electric wave characteristics on the above-mentioned surrounding environments can be minimized. The above-described operation is executed by a mobility detection algorithm that will be described later on.

In the preparation state, the mobile node attempts to make a connection in advance to Next_AP in order to execute handover rapidly even when moving at high speed. In the concrete, the interface of the preparation state establishes in advance a connection to Next_AP by exchanging authentication and association messages with Next_AP. Thereafter, an RSSI received from Next_AP is measured and AP switch is prepared. At this time, the signaling strength of the electric wave signal RSSI received from Next_AP is measured in real-time by using the probe message rather than a broadcasting beacon message that is periodically transmitted from Next_AP. When the signaling strength received from Next_AP is greater than Ts, that is, the handover threshold value or the signaling strength received from Current_AP, the mobile node immediately changes the point of attachment to Next_AP from Current_AP, thereby completing AP handover. At this time, the mobile node switches from the handover preparation state to the handover completion state. Furthermore, the Ts value is not a fixed value, but depends on a mobility pattern of the mobile node. After the mobile node has changed to Next_AP, the interface connected to Current_AP goes into the sleep state.

A method of finding the estimated value of the moving average value in variation of the electric wave intensity depending on variation in time is then described below. Here, RSSIᵢ(AP) denotes the value of a RSSI received from an AP in the time slot i. Sᵢ (AP) denotes the estimated value of the average value of the RSSI received from the AP in the time slot i. Then,

$$S ( AP ) = ( 1 - μ ) {S}_{- 1} ( AP ) + μ \{ {RSSI}_{i} ( AP ) - {RSSI}_{- 1} ( AP ) \}$$

Sᵢ denotes the estimated value of the moving average value of the RSSI. In general, the value

μ
is suitably set to be about 0.4, but can have an optimal value experimentally by taking surrounding electric wave environments into account. In particular, in the case where the mobile node moves between several neighboring cells here and there, unnecessary handover can be decreased by controlling the values Tp and Ts. Consequently, the intelligent handover mechanism on which the surrounding electric wave environments and the mobility pattern of the mobile node are reflected can significantly reduce signaling overhead and delay caused by ping-pong movement between neighboring cells, which frequently occurs in the intra-domain.

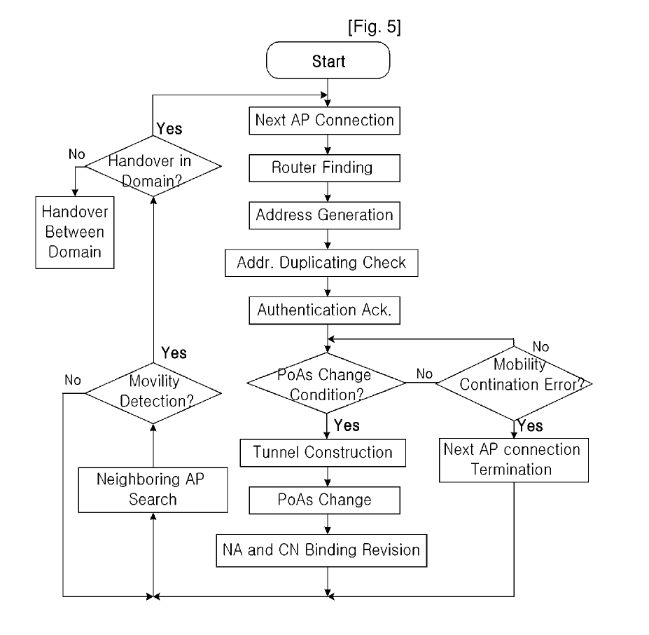

A construction of the fast intra-domain mobility management method according to the present invention is described below. FIG. 5 illustrates a fast intra-domain mobility management algorithm according to the present invention. In FIG. 5, the state (A) indicates the state of the interface A, and the state (B) indicates the state of the interface B. The fast intra-domain mobility management algorithm begins in a state where one (the interface A) of the two interfaces is initially in the active state and the other (the interface B) of the two interfaces is in the sleep state.

A movement of the mobile node is monitored and analyzed by the mobility detection algorithm. If it is determined that the mobile node moves, the interface being in the sleep state enters “Prepare Handover”, that is, the handover preparation state. The interface in preparation state checks in real-time whether the interface of the mobile node has entered a next cell region. If the electric wave intensity of the interface B, which is received from Next_AP, is greater than the electric wave intensity received from Current_AP or the switch threshold value Ts, the interface B is activated, an AP is switched, and the interface A is then inactivated to enter the sleep state. In this case, if the electric wave intensity of the interface B is not greater than the electric wave intensity received by the interface A that is currently being used or the switch threshold value Ts, variation in the electric wave intensity is continuously checked to determine the movement situation of the mobile node. If the electric wave intensity received from the interface B is significantly reduced and smaller than the value Tp, the interface B returns to its original state. The lower part of FIG. 5 corresponds to a part in which the roles of the interfaces A and B are switched and will not be described in detail.

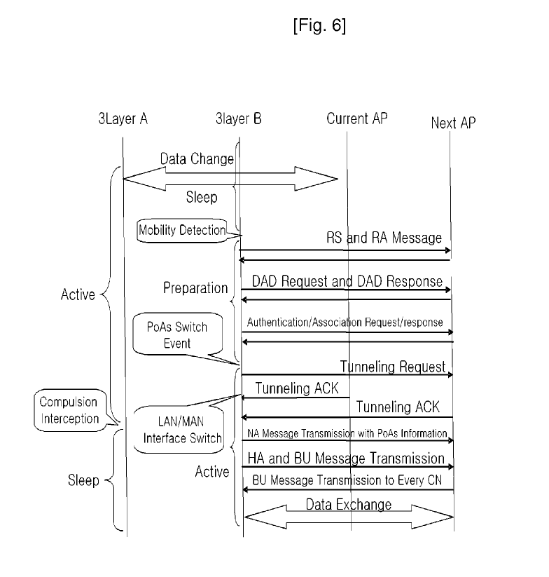

FIG. 6 illustrates the signaling sequence diagram of intra-domain handover. In FIG. 6, the interface A of the mobile node is connected to Current_AP and transmits and receives data, in the active state. The interface B receives RSSI signaling information from Next_AP. Next_AP is an adjacent AP having the greatest moving average value of the received electric wave intensity as described before. As mentioned earlier, if the movement of the mobile node is detected according to mobility detection, that is, the moving average value of the electric wave intensity of the interface B, which is received from Next_AP, is greater than Tp, the interface B enters the preparation state and sets connection by sending the authentication and association request signals to Next_AP. At the same time, the interface B rapidly checks variation in the electric wave intensity depending on the movement of the mobile node by sending the probe message to Next_AP. In this case, if the RSSI received from Next_AP is greater than Ts, that is, it is determined that the mobile node has entered a cell governed by Next_AP, the point of attachment of the mobile node is immediately changed to Next_AP by means of the switch AP event, and AP handover is thus executed. In this case, since the connection to the interface A is disconnected at Layer 3 of the mobile node, the interface A switches from the active state to the sleep state. When the electric wave intensity is smaller than Tp, the interface A can disconnect the connection automatically. However, in the case of fast moving, it is advantageous to forcedly disconnect the connection at the mobility management module in preparing next handover.

In FIG. 6, the interface B of the mobile node detects the movement of the mobile node when the interface A is activated. When the detected value is greater than Tp, the interface B of the mobile node makes association with Next_AP, and is then preparing for the possible handover. If the electric wave intensity received from Next_AP is greater than the value Ts due to the movement of the mobile node, it is determined that the mobile node has entered a cell governed by Next_AP. Thus, the point of attachment of the mobile node can be immediately changed to Next_AP. After the interface B is connected to Next_AP, the connection of the interface A and Current_AP is disconnected. This is the make-before-break principle and is called alternate make-before-break because the roles of the interfaces A and B are alternately changed. In reality, in the preparation state, the probe request/response message can be performed within several milliseconds. Thus, if the RSSI becomes greater than the value Ts due to the movement of the mobile node, AP handover can be performed without data loss or time delay by changing the AP immediately.

The intra-domain mobility management method of the mobile node in the wireless LAN/MAN according to the present invention can be summarized as follows. The method includes the steps of a) preparing handover by allowing one interface to measure the electric wave intensity based on the alternate make-before-break principle by using two interfaces in order to prevent data loss and delay caused by handover while the mobile node moves, and b) performing handover by using the two interfaces. The steps of performing handover by using two interfaces during the movement of a mobile node consists of the sleep state, the handover preparation state and the active state. These steps have been designed in order to save power consumption and prevent data loss and delay during handover. These steps are distinguished by two threshold values, Tp and Ts. Tp is the handover preparation threshold value Tp by which an interface that is in the sleep state is awakened and prepared for handover when the mobile node moves to a next AP direction. Ts is the switch threshold value by which handover is performed after the preparation state.

The intra-domain mobility management system of the mobile node in the wireless LAN/MAN according to the present invention can be summarized as follows. The intra-domain mobility management system is a fast intra-domain mobility management system, including a) two LAN/MAN interfaces in which one interface of the two interfaces measures the electric wave intensity and is alternately prepared for handover based on the alternate make-before-break principle in order to prevent data loss and time delay due to handover when the mobile node moves, and b) steps of preparing and performing handover by using the two interfaces in such a manner that an estimated of average values of RSSI is appropriately utilized in order to provide robust as well as intelligent handover operation in a fluctuating electrical wave environments, preventing ping-pong movement. Each of two interfaces constituting the wireless LAN or MAN data link layer can be implemented in a LAN or MAN card, or two interfaces can be constructed in one LAN or MAN card.

### INDUSTRIAL APPLICABILITY

According to the present invention, in view of the wireless LAN/MAN development direction in recent years, the data transfer rate abruptly increases, whereas the cost abruptly drops. Thus, users can use the mobility management system according to the present invention without economic burden. Further, the present invention can be applied to other wireless LAN/MAN techniques that evolve in various ways since it is independent from Layer 2. In particular, there is no need to change a wireless communication-based structure. Further, when considering that most user mobility (about 70%) is regional mobility within limited regions such as campuses, companies and factories, the mobility management method according to the present invention can has a high applicability to the industry.

1. A fast intra-domain mobility management method of a mobile node in a wireless LAN or MAN, comprising the steps of:
allowing a mobile node to have two LAN/MAN interfaces mounted therein, measure an electric wave intensity of an adjacent AP by using an interface that is not in use based on an alternate make-before-break principle, and alternately prepare handover with an interface that is in use, in order to prevent data loss and time delay due to the handover when the mobile node moves; and
alternately performing handover between APs at high speed by using the two interfaces based on the measured electric wave intensity of the an adjacent AP.

2. The fast intra-domain mobility management method of claim 1, wherein in the step of preparing handover by using the two interfaces in order to prevent data loss and delay due to the handover while the mobile node moves, the state of the interface includes a sleep state, a handover preparation state and an active state in order to save unnecessary power consumption and prevent data loss and delay due to the handover.

3. The fast intra-domain mobility management method of claim 1 or 2, wherein the step of preparing handover by using the two interfaces in order to prevent data loss and delay due to handover while the mobile node moves includes a handover preparation threshold value Tp which determines when an interface in the sleep state should be awakened and prepared for handover when the mobile node moves to a next AP direction, and a switch threshold value Ts which determines when the handover should be performed after the preparation state.

4. The fast intra-domain mobility management method of claim 3, wherein the handover preparation threshold value Tp and the switch threshold value Ts are differently set depending on electric wave environments or a mobility pattern so that a ping-pong phenomenon can be decreased when the mobile node moves at a boundary of cells.

5. The fast intra-domain mobility management method of claim 4, wherein in measuring the electric wave intensity from each adjacent AP, in the sleep state, entry to the preparation state is determined by using a moving average value of the electric wave intensity depending on time variation in order to minimize unnecessary handover due to an abrupt change of the electric wave intensity, and in the preparation state, an electric wave intensity of an AP that is in use or the switch threshold value Ts and an electric wave intensity of an AP that is being prepared for handover are compared according to a probe message or an AP-broadcasted message, and when the electric wave intensity of the AP that is being prepared for handover is greater than the electric wave intensity of the AP that is in use or the switch threshold value Ts, fast AP switching is performed.

6. The fast intra-domain mobility management method of claim 3, wherein a moving state transition event includes:
a forward mobility detection event to determine whether a mobile node that is in a handover completion state has moved to other adjacent AP by using an interface that is in the sleep state;
a backward mobility detection event to determine whether a mobile node that is in the handover preparation state has returned to a previous state;
a no mobility event to determine whether the mobile node that is in the handover completion state moves very slowly or has stopped;
a waiting for switching event to determine that a mobile node is not in a state whose handover should not be performed though the mobile node is being moved; and
a switch AP event to instruct change of an AP.

7. A fast intra-domain mobility management system of a mobile node in a wireless LAN or MAN, comprising:
two LAN/MAN interfaces mounted in the mobile node and configured to measure an electric wave intensity of an adjacent AP by using an interface that is not in use based on an alternate make-before-break principle, and alternately prepare handover with an interface that is in use, in order to prevent data loss and time delay due to the handover when the mobile node moves; and
means of alternately performing handover between APs at high speed by using the two interfaces based on the measured electric wave intensity of the an adjacent AP.

8. The fast intra-domain mobility management system of claim 7, wherein the two interfaces used to prevent data loss and delay due to the handover while the mobile node moves includes a sleep state, a handover preparation state and an active state in order to save power consumption and prevent data loss and delay due to the handover.

9. The fast intra-domain mobility management system of claim 7 or 8, wherein the step of preparing handover by using the two interfaces in order to prevent data loss and delay due to handover while the mobile node moves includes a handover preparation threshold value Tp which determines when an interface in the sleep state should be awakened and prepared for handover when the mobile node moves to a next AP direction, and a switch threshold value Ts which determines when the handover should be performed after the preparation state.

10. The fast intra-domain mobility management system of claim 9, further comprising means for setting the handover preparation threshold value Tp and the switch threshold value Ts differently depending on electric wave environments or a mobility pattern in order to decrease a ping-pong phenomenon when the mobile node moves at a boundary of cells.

11. The fast intra-domain mobility management system of claim 9, wherein in measuring the electric wave intensity from each adjacent AP, in the sleep state, entry to the preparation state is determined by comparing a moving average value of an electric wave intensity depending on time variation and the handover preparation threshold value Tp in order to minimize unnecessary handover due to an abrupt change of the electric wave intensity, and in the preparation state, an electric wave intensity of an AP that is in use or the switch threshold value Ts and an electric wave intensity of an AP that is being prepared for handover are compared according to an AP probe message, and when the electric wave intensity of the AP that is being prepared for handover is greater than the electric wave intensity of the AP that is in use or the switch threshold value Ts, fast AP switching is performed.

12. The fast intra-domain mobility management system of claim 7 or 8, further comprising means for receiving a broadcasting beacon frame message that is periodically transmitted from an adjacent AP in order to save power consumption at the mobile node.
